(19) United States
(12) Patent Application Publication
(10) Pub. No.: US 2010/0154187 A1
(43) Pub. Date: Jun. 24, 2010

(54) Pipe-lining material and pipe-lining method

(75) Inventors: Takao Kamiyama, Hiratsuka-shi (JP); Koji Kaneta, Hiratsuka-shi (JP); Kenji Fujii, Hiratsuka-shi (JP); Kazuaki Ogura, Hiratsuka-shi (JP)

Correspondence Address: BRUCE L. ADAMS, ESQ.;ADAMS & WILKS, 17 BATTERY PLACE- SUITE 1231, NEW YORK, NY, 10004, US

(73) Assignee: SHONAN GOSEI-JUSHI SEISAKUSHI K.K

(21) Appl. No.: 12/655,095

(22) Filed: Dec. 23, 2009

(30) Foreign Application Priority Data
Dec. 24, 2008 (JP) 2008-326760

(51) Int. Cl. B23P 6/04; F16L 55/16

(52) U.S. Cl. 29/402.16; 138/98

(57) ABSTRACT

The pipe-lining material includes a pipe-shaped resin absorbent material impregnated with a liquid curable resin, and a tube that covers the pipe-shaped resin absorbent material and that can be removed from the pipe-shaped resin absorbent material. The curable resin impregnated in the pipe-shaped resin absorbent material is cured in a state in which the pipe-lining material is pressed against the internal peripheral surface of the existing pipe, the tube covering the pipe-shaped resin absorbent material of the pipe-lining material is removed from the pipe-shaped resin absorbent material after the curable resin impregnated in the pipe-shaped resin absorbent material has been cured, and the surface of the pipe-shaped resin absorbent material having the cured resin is used as the internal peripheral surface of the rehabilitated existing pipe. The internal peripheral surface can be prevented from becoming rough and the coefficient of roughness of the internal peripheral surface of the rehabilitated existing pipe can be reduced because the internal peripheral surface of the existing pipe is a cured, firm resin surface.

### BACKGROUND OF THE INVENTION

1. Field of the Invention

The present invention relates to a pipe-lining material and a pipe-lining method using the pipe-lining material for rehabilitating clean water pipes, sewage pipes, agricultural water pipes, and other existing pipes that have deteriorated.

2. Description of the Related Art

Pipe-lining methods are known in the art (e.g., Japanese Laid-open Patent Application No. 6-114939) in which an existing pipe is lined with a pipe-lining material in order to rehabilitate the existing pipe without unearthing the existing pipe when the underground existing pipe has deteriorated. The pipe-lining material is impregnated with an uncured liquid curable resin (e.g., a thermosetting resin) in the pipe-shaped resin absorbent material composed of a soft pipe-shaped nonwoven that corresponds to the shape of the existing pipe. A plastic film composed of a highly airtight polyethylene or the like for covering the pipe-shaped resin absorbent material is coated onto the external peripheral surface of the pipe-shaped resin absorbent material. This is carried out in order to waterproof the pipe-lining material and to prevent the liquid curable resin from leaking out. In the lining construction, the lining process is carried out by everting the pipe-lining material (turning the inside out) inside the existing pipe and using heat or another method to cure the liquid curable resin impregnated in the pipe-lining material in a state in which the pipe-lining material is pressed against the internal peripheral surface of the existing pipe.

The method described above envisions a main pipe as the existing pipe, but application can also be made to an existing pipe such as a lateral pipe that branches from the main pipe. Such a method is described, e.g., in Japanese Laid-open Patent Application No. 4-355115. With this lateral pipe lining method, the lateral-pipe lining material having a flange formed at one end and housed in a pressure bag is positioned on a positioning nozzle of a work robot introduced inside the main pipe, and compressed air is fed inside the pressure bag. The lateral-pipe lining material is pressed by the pressure of the compressed air and is sequentially everted and inserted inside the lateral pipe from the main pipe toward aboveground. The internal peripheral surface of the lateral pipe is lined by applying heat to cure the thermosetting resin impregnated in the lateral-pipe lining material while the material is pressed against the internal peripheral surface of the lateral pipe. Similarly to the pipe-lining material of a main pipe, the pipe-lining material for a lateral pipe is also one in which the pipe-shaped resin absorbent material composed of a soft pipe-shaped nonwoven is impregnated with an uncured liquid curable resin (e.g., a thermosetting resin), and a plastic film composed of a highly airtight polyethylene or the like for covering the pipe-shaped resin absorbent material is coated onto the external peripheral surface of the pipe-shaped resin absorbent material.

In the pipe-lining materials of the prior art, the durability (abrasion resistance, acid resistance, and other attributes) of the polyethylene films or other plastic films coated onto the pipe-shaped resin absorbent material is inferior to that of a cured resin (unsaturated polyester, vinyl ester, or the like) impregnated into the pipe-shaped resin absorbent material, whether the application is for a main pipe or a lateral pipe. Accordingly, when the plastic film affixed to the internal peripheral surface of the pipe-shaped resin absorbent material of the pipe-lining material is left behind at the end of lining construction and the existing pipe is used again, the plastic film peels away as time passes and obstructs the flow of sewage or the like inside the pipeline.

For this reason, there is a problem in lining construction in that work for peeling away the plastic film affixed to the internal peripheral surface of the pipe-shaped resin absorbent material of the pipe-lining material is carried out after the curable resin of the pipe-lining material has been cured, and the work extends the construction time and increases costs.

There are also cases in which the entire plastic film cannot be cleanly peeled away and the internal peripheral surface of the pipe-lining material is damaged. In such cases, the aesthetic appearance is degraded, the coefficient of roughness of the internal peripheral surface of the pipe-lining material is increased, and quantity of the flow inside the existing pipe is reduced. There is also a problem in that costs are incurred for disposing the plastic film thus peeled away.

### SUMMARY OF THE INVENTION

It is an object of the present invention to provide a pipe-lining material and a pipe-lining method using the pipe-lining material in which the pipe-lining construction can be carried out in a simple manner in a short period of time, and in which construction costs can be reduced and the pipe-lining material workmanship can be improved.

According to an aspect of the present invention, there is provided a pipe-lining material for insertion into an existing pipe and rehabilitation of the internal peripheral surface of the existing pipe. The pipe-lining material comprises a pipe-shaped resin absorbent material impregnated with a liquid curable resin; and a tube covering the external peripheral surface or the internal peripheral surface of the pipe-shaped resin absorbent material, the tube being removably attached to the pipe-shaped resin absorbent material.

According to another aspect of the present invention, there is also provided a pipe-lining method for rehabilitating the internal peripheral surface of an existing pipe using a pipe-lining material. The pipe-lining method comprises inserting a pipe-lining material having a pipe-shaped resin absorbent material and a tube into an existing pipe so that the pipe-shaped resin absorbent material faces outward and the tube faces inward, the pipe-lining material having a pipe-shaped resin absorbent material impregnated with a liquid curable resin, and the tube covering the external peripheral surface or the internal peripheral surface of the pipe-shaped resin absorbent material and being removable from the pipe-shaped resin absorbent material; curing the curable resin impregnated in the pipe-shaped resin absorbent material in a state in which the pipe-lining material is pressed against the internal peripheral surface of the existing pipe; curing the curable resin impregnated in the pipe-shaped resin absorbent material; and subsequently removing the tube covering the pipe-shaped resin absorbent material from the pipe-shaped resin absorbent material so that the surface of the pipe-shaped resin absorbent material having the cured resin will be the internal peripheral surface of the rehabilitated existing pipe.

According to the present invention, a pipe-lining material is inserted into an existing pipe, and the internal peripheral surface of the existing pipe is lined with a cured pipe-shaped resin absorbent material, after which a tube covering the external peripheral surface or the internal peripheral surface of the pipe-shaped resin absorbent material is removed. Accordingly, the internal peripheral surface of the rehabilitated existing pipe after having been lined is a firm resin surface. It is therefore possible to prevent the coating layer from gradually peeling and falling away from the internal peripheral surface of the rehabilitated existing pipe and thereby to prevent the internal peripheral surface from becoming rough, because no coating layer covers the resin surface. The coefficient of roughness of the internal peripheral surface of the rehabilitated existing pipe is reduced and thereby quantity of water flowing through the existing pipe can be increased.

### BRIEF DESCRIPTION OF THE DRAWINGS

FIG. 1a is a perspective view showing the configuration of the main-pipe lining material, and FIG. 1b is an enlarged cross-sectional view of the end part of the main-pipe lining material;

FIG. 2 is a cross-sectional view showing a construction in which a main pipe is lined using the main-pipe lining material;

FIG. 3 is a cross-sectional view showing the step for removing the tube of the main-pipe lining material after lining;

FIG. 4 is a cross-sectional view showing a main pipe rehabilitated by the main-pipe lining material;

FIG. 5a is a cross-sectional view showing the configuration of the lateral-pipe lining material, and FIG. 5b is an enlarged cross-sectional view of the end part of the lateral-pipe lining material;

FIG. 6 is a cross-sectional view showing a construction in which a lateral pipe is lined using the lateral-pipe lining material;

FIG. 7 is a cross-sectional view showing the step for inserting the lateral-pipe lining material into the lateral pipe by eversion;

FIG. 8 is a cross-sectional view showing the step for removing the tube of the lateral-pipe lining material;

FIG. 9 is a cross-sectional view showing a lateral pipe rehabilitated by the lateral-pipe lining material;

FIG. 10 is a cross-sectional view showing the construction for extending the lateral-pipe lining material to aboveground and lining the lateral pipe; and

FIG. 11 is a cross-sectional view showing the step for removing the tube of the lateral-pipe lining material.

### DESCRIPTION OF THE PREFERRED EMBODIMENTS

Now, referring to the drawings, description is made about embodiments of the present invention. The description is herein made as regards a lining for a main pipe and a lateral pipe that branches from the main pipe such as a clean water system or a sewage system as an existing pipe. However, the present invention is not limited to a case of lining the existing pipe of a clean water system and a sewage system but can be applied to other cases in which agricultural water pipes or other existing pipes are to be lined.

### Embodiment 1

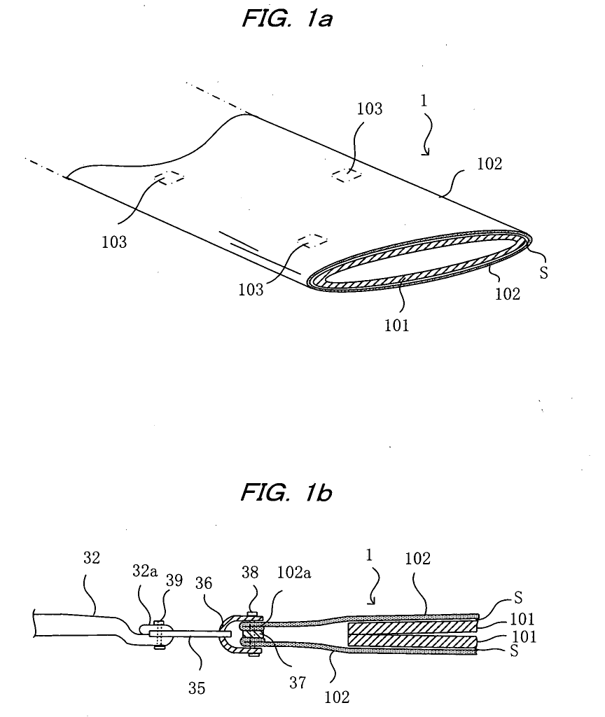

FIG. 1 shows a main-pipe lining material (hereinafter referred to as main-pipe lining material) for lining the internal peripheral surface of a sewage system main pipe as the existing pipe.

The main-pipe lining material 1 is comprised of a flexible pipe-shaped resin absorbent material 101 in which the external peripheral surface (which becomes the internal peripheral surface after eversion) thereof is covered with a soft tube 102 composed of polyethylene, polypropylene, nylon, vinyl chloride, or another highly airtight plastic film. The pipe-shaped resin absorbent material 101 is composed of a matte, a woven, or a nonwoven using polyamide, polyester, polypropylene, or another plastic fiber; a matte or a woven using glass fiber; or a matte, a woven, or a nonwoven that combines the use of the above-noted plastic fiber and fiber glass. The pipe-shaped resin absorbent material 101 is impregnated with unsaturated polyester resin, vinyl ester resin, epoxy resin, or another uncured liquid thermosetting resin.

The tube 102 peelably covers the external peripheral surface of the pipe-shaped resin absorbent material 101 in order to waterproof the main-pipe lining material 1 and to prevent the liquid curable resin impregnated in the pipe-shaped resin absorbent material 101 from leaking out. Conventionally, the tube 102 is heat-fused to the entire external peripheral surface of the pipe-shaped resin absorbent material 101 and cannot be peeled away. However, in the present invention, the tube 102 has a slight gap S relative to the external peripheral surface of the pipe-shaped resin absorbent material 101 or covers the entire pipe-shaped resin absorbent material 101 merely by contact and is not heat-fused to the pipe-shaped resin absorbent material 101; namely, is not secured to the pipe-shaped resin absorbent material 101, in order to allow the tube 102 to be torn off and readily removed, after the lining construction has been completed.

In the case that the tube 102 is not secured to the pipe-shaped resin absorbent material 101 in any way, the tube 102 is liable to become positionally displaced with respect to the pipe-shaped resin absorbent material 101. Therefore, the tube 102 and the pipe-shaped resin absorbent material 101 may be partially heat-fused or bonded so as to be temporarily secured, as indicated by the reference numeral 103 in FIG. 1a. In such a case, the size of the heat-fused locations and the number of the heat-fused locations are set so that the tube 102 can be readily peeled away from the cured pipe-shaped resin absorbent material 101, as will later be described.

One end (the right side) of the main-pipe lining material 1 is opened, as shown in FIG. 1a, and is mounted on the opening of a pressure container, as will later be described. At the other end of the main-pipe lining material 1, the tube 102 is longer than the pipe-shaped resin absorbent material 101, and the end part 102a is folded in multiple layers, as shown in FIG. 1b. The folded end part 102a of the tube 102 is secured to a metal or plastic connector 36 using a bolt 38 or another securing device through a fixed plate 37 made of a plastic material. The connector 36 is connected through a rope 35 to an end part 32a of a later-described hot-water hose 32 by a bolt 39.

Accordingly, the tube 102 can be removed from the pipe-shaped resin absorbent material 101 without tearing even when the tube 102 is drawn by the rope 35, because the end part 102a of the tube 102 is thus folded in multiple layers and secured by the bolt 38 through the fixed plate 37.

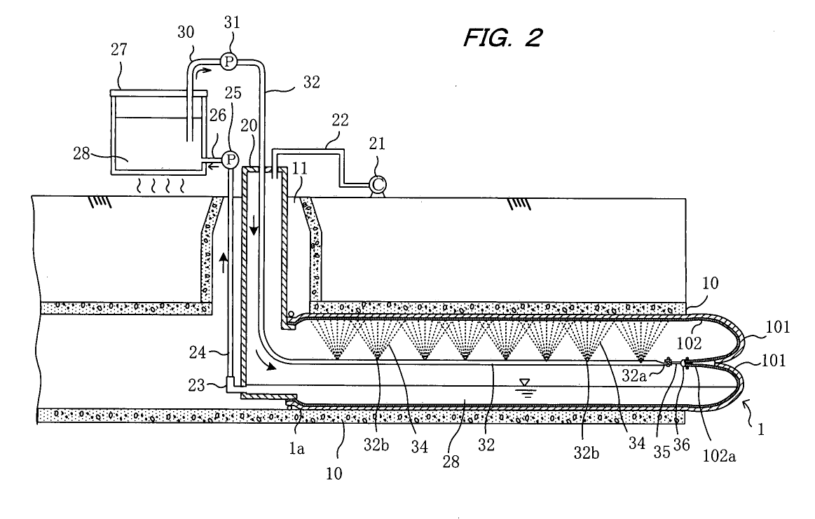

FIG. 2 is an illustrative view showing a construction when a main pipe is lined using the main-pipe lining material 1 described above.

The distal end 1a of the main-pipe lining material 1 (the right side portion of FIG. 1a) is coupled in an airtight manner to an opening formed in the lower end of a pressure container 20 set up inside a manhole 11.

An air compressor 21 is connected to the pressure container 20 through a pipe 22. A drainage pipe 23 is provided to the lower part of the pressure container 20, and a drainage hose 24 connected to a drainage pump 25 set up aboveground is connected to the drainage pipe 23. The drainage pump 25 is connected to the lower part of a hot-water tank 27 through a pipe 26, and hot water 28 that resides in the lower part of the main-pipe lining material 1 during the curing process is circulated back to the hot-water tank 27, as will later be described. The hot-water tank 27 is heated by a heater (not shown), and the hot water 28 is kept hot at a predetermined temperature. A hot-water pump 31 is connected to the upper part of the hot-water tank 27 through a pipe 30, and a hot-water hose 32 is connected to the hot-water pump 31.

The hot-water hose 32 is inserted into the main-pipe lining material 1 through the interior of the pressure container 20, and the distal end 32a of the hot-water hose 32 is coupled through the connector 36 to the distal end part 102a of the tube 102 of the main-pipe lining material 1 using the rope 35, as described above. The hot-water hose 32 is inserted into the main pipe 10 as the main-pipe lining material 1 is being inserted. Numerous discharge ports 32b are formed in the hot-water hose 32, and hot water is discharged as a hot water mist 34 or a hot water shower toward the main-pipe lining material 1 through the discharge ports 32b.

In such a configuration, the main-pipe lining material 1 is stored inside the pressure container 20 (or fed into the pressure container 20 in an airtight manner from the exterior) and the open end 1a of the main-pipe lining material 1 is mounted in an airtight manner to the opening formed in the lower part of the pressure container 20. The main-pipe lining material 1 is inserted into the main pipe 10 while being everted when compressed air is fed from the air compressor 21 into the pressure container 20.

When the main-pipe lining material 1 is inserted by a predetermined length, the hot water 28 from the hot-water tank 27 is fed to the hot-water hose 32 by the hot water pump 31. The main-pipe lining material 1 is expanded by the compressed air and is pressed against the internal peripheral surface of the main pipe 10. In this state, hot water is sprayed as a hot water mist 34 or hot showering from the discharge ports 32b of the hot-water hose 32 onto the internal peripheral surface of the main-pipe lining material 1. Therefore, curing proceeds in the thermosetting resin with which the pipe-shaped resin absorbent material 101 is impregnated, thereby lining the internal peripheral surface of the main pipe 10 using the main-pipe lining material.

The hot water discharged onto the main-pipe lining material 1 is collected as hot water 28 below. The hot water is returned to the hot-water tank 27 through the drainage pipe 23 or the like, and is reheated and fed as hot water at a predetermined temperature to the hot-water hose 32. It is therefore possible to perform lining construction with energy saved because a hot water circulation system is formed. The resin impregnated in the pipe-shaped resin absorbent material 101 can be uniformly cured, because the hot water is discharged as a mist or a shower.

A start liner (not shown) may be inserted into the main pipe prior to inserting the main-pipe lining material 1 into the main pipe 10 by eversion to prevent underground water or sewage from leaking into the main pipe. The main-pipe lining material 1 may then be inserted by eversion inside the start liner.

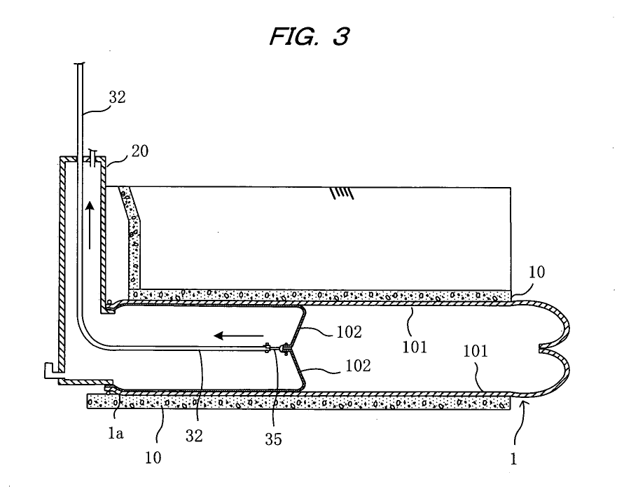

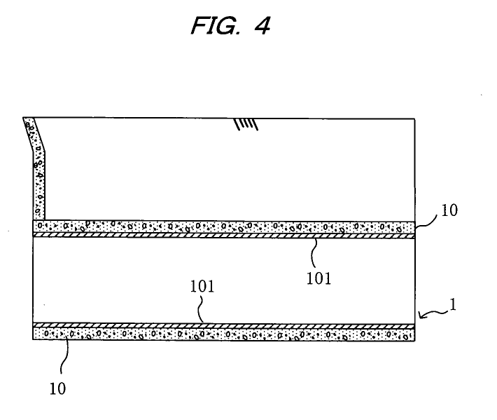

When the thermosetting resin impregnated in the pipe-shaped resin absorbent material 101 of the main-pipe lining material 1 is cured and the internal peripheral surface of the main pipe 10 is lined, the hot-water hose 32 is pulled up and the rope 35 connected to the distal end of the hot-water hose 32 is pulled, as shown in FIG. 3. The tube 102 of the main-pipe lining material 1 connected to the rope 35 is thereby also pulled. Since the tube 102 is not secured to the pipe-shaped resin absorbent material 101 or is only partially secured to the pipe-shaped resin absorbent material 101, the tube 102 separates and is removed from the pipe-shaped resin absorbent material 101 as the hot-water hose 32 or the rope 35 is pulled. After the tube 102 has been completely removed, the main-pipe lining material 1 protruding from the main pipe 10 is cut off and the lining construction is ended, as shown in FIG. 4.

The internal peripheral surface of the main pipe 10 after lining is a firm resin surface composed of the pipe-shaped resin absorbent material 101 of the main-pipe lining material 1, and a coating layer (tube 102) for coating the resin surface is not left behind in the conventional manner. It is therefore possible to prevent the situation occurring in the past, in which the coating layer gradually peels and falls away from the internal peripheral surface of the rehabilitated main pipe and the internal peripheral surface becomes rough. Thus, in the present invention, the internal peripheral surface of the rehabilitated main pipe can be provided with a resin surface having no coating layer, and the coefficient of roughness of the internal peripheral surface can be reduced and quantity of the flow of the sewage inside the main pipe 10 can be increased.

The main-pipe lining material described above is inserted into a main pipe by eversion, but the same configuration can be achieved when the main-pipe lining material is drawn into the main pipe. In the case that the main-pipe lining material is drawn into the main pipe, the main-pipe lining material is inserted into the main pipe so that the pipe-shaped resin absorbent material is outside and the tube for covering the internal peripheral surface of the pipe-shaped resin absorbent material is inside. The tube is coupled so that the tube can be removed using the rope or the hot-water hose. Therefore, after the resin impregnated in the pipe-shaped resin absorbent material has cured, the tube can be readily removed from the pipe-shaped resin absorbent material by pulling the rope or the hot-water hose in the same manner as the main-pipe lining material for eversion described above.

In the case that the main-pipe lining material is comprised of a multilayered pipe-shaped resin absorbent material, it is possible to insert the main-pipe lining material into the existing pipe and then remove the tube for covering the pipe-shaped resin absorbent material of the innermost main-pipe lining material from the pipe-shaped resin absorbent material.

### Embodiment 2

The embodiment 1 described above relates to a main-pipe lining material for lining the internal peripheral surface of a main pipe, but the present invention can also be applied to a pipe-lining material for a lateral pipe (hereinafter referred to as lateral-pipe lining material) for lining the internal peripheral surface of a lateral pipe that intersects with a main pipe and can be applied to construction for lining the lateral pipe.

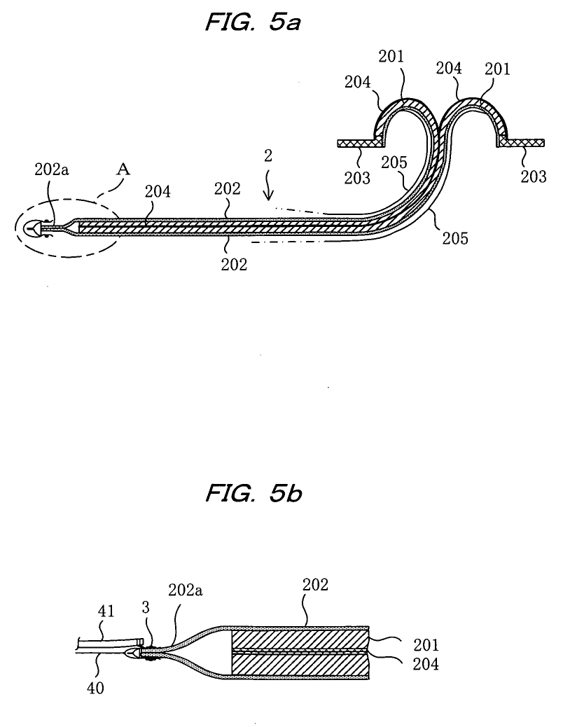

FIGS. 5a and 5b show the lateral-pipe lining material 2. The lateral-pipe lining material 2 has a flexible pipe-shaped resin absorbent material 201 composed of the same material as the pipe-shaped resin absorbent material 101 of the main-pipe lining material 1. The pipe-shaped resin absorbent material 201 is impregnated with unsaturated polyester resin, vinyl ester resin, epoxy resin, or another uncured liquid thermosetting resin. Polyethylene, polypropylene, nylon, vinyl chloride, or another highly airtight plastic film is heat-fused on the internal peripheral surface (which becomes the external peripheral surface after eversion) of the pipe-shaped resin absorbent material 201 to form a coating layer 204. One end of the pipe-shaped resin absorbent material 201 is folded back, and the thermosetting resin in the folded portion is cured to form a firm flange 203.

The pipe-shaped resin absorbent material 201 is inserted by eversion into the tube (inner tube) 202 which is longer than the pipe-shaped resin absorbent material 201 and of which an end is heat-fused or otherwise secured to the flange 203. The tube 202 is composed of polyethylene, polypropylene, nylon, vinyl chloride, or another highly airtight plastic film in the same manner as the tube 102, and the portion opposite to the flange 203 of the tube 202 is closed in an airtight manner using a nut and bolt or another securing device 3, as shown in FIG. 5b, and a drawing rope 40 and a hot-water hose 41 are connected to the portion thus closed in the airtight manner. The tube 202 is not secured to the pipe-shaped resin absorbent material 201 except that one end is heat-fused and temporarily secured to the flange 203. A peel-away tube 205 having a predetermined length is passed over the exterior of the pipe-shaped resin absorbent material 201, and one end of the peel-away tube 205 is peelably bonded to the external periphery in the vicinity of the flange 203. The other end is opened and coupled in an airtight manner to a portion of a later-described pressure bag. The same material as the tube 202 may be used for the peel-away tube 205.

Next, description proceeds to the lateral-pipe lining method carried out using the lateral-pipe lining material 2.

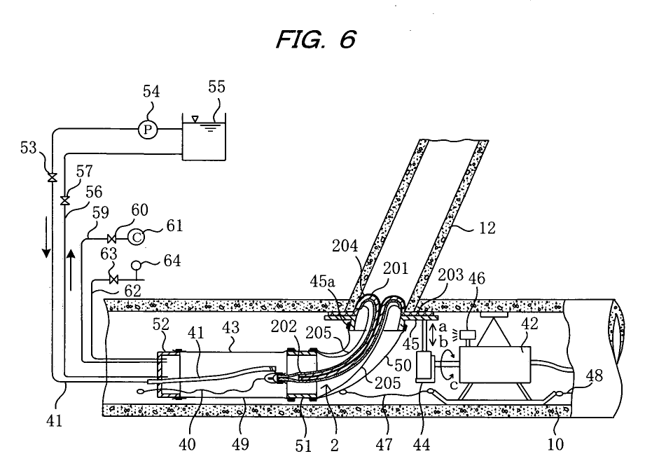

In FIG. 6, the reference numeral 12 is a small-diameter lateral pipe that branches from the main pipe 10, and a work robot 42, a pressure bag 43, the lateral-pipe lining material 2 for a lateral pipe, and other components are being drawn into the main pipe 10.

The work robot 42 has a head 44 that reciprocates in the vertical direction a, b in FIG. 6, and is configured so as to rotate about the pipe axis in the manner indicated by the arrow c. A flange-shaped positioning nozzle 45 is supported by the head 44. A TV camera 46 for monitoring is disposed on the upper part of the work robot 42. Draw ropes 47, 48 are attached to the front and rear of the work robot 42. One draw rope 47 is connected to the pressure bag 43, and the other draw rope 48 is extended to aboveground.

Meanwhile, the pressure bag 43 has a configuration in which two flexible tubes 49, 50 are coupled together by a cylindrical joint 51. The open end of the tube 49 is closed by a cap 52, and the open end of the other tube 50 is mounted on the cylindrical part 45a of the positioning nozzle 45. The other end (open end) of the peel-away tube 205 mounted on the external periphery of the pipe-shaped resin absorbent material 201 is mounted in an airtight manner on the external periphery of the joint 51 together with the tube 50.

The flange 203 of the lateral-pipe lining material 2 is positioned on the positioning nozzle 45, and the other uneverted portions are passed through the positioning nozzle 45 and stored inside the pressure bag 43. At this point, the drawing rope 40 connected to the tube 202 of the lateral-pipe lining material 2 is attached to the cap 52, and the hot-water hose 41 is extended to the exterior of the pressure bag 43 through the cap 52 and brought to a valve 53. Hot water is fed from a hot-water tank 55 heated by a heat source (not shown) to the hot-water hose 41 by a hot-water pump 54. The hot water inside the pressure bag 43 is returned to the hot-water tank 55 through a drainage hose 56 and a valve 57.

An airtight space closed off by the peel-away tube 205 and the tube 202 of the lateral-pipe lining material 2 is formed inside the pressure bag 43, and the airtight space is connected to a compressor 61 disposed aboveground through an air hose 59 and a valve 60, and is in communication with the exterior through a drainage hose 62 and a valve 63. A pressure gauge 64 is mounted on the drainage hose 62.

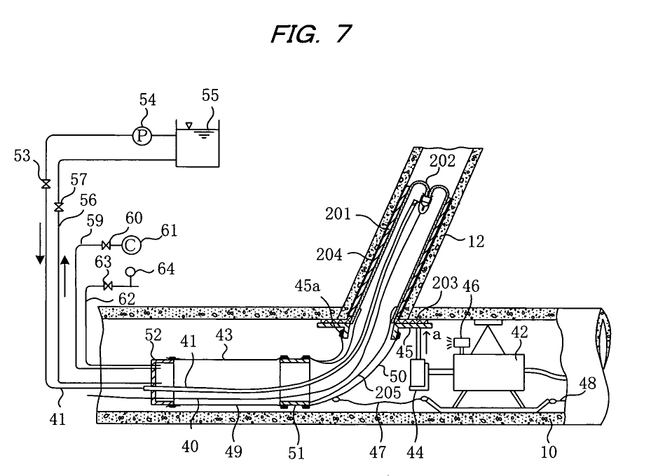

As described above, the head 44 of the work robot 42 is moved upward in the direction of the arrow a, and the flange 203 of the lateral-pipe lining material 2 is pressed in close contact against the peripheral wall of the lateral pipe opening of the main pipe 10, as shown in FIG. 6. When the compressor 61 is driven and compressed air is fed to the airtight space inside the pressure bag 43 through the air hose 59, the lateral-pipe lining material 2 is pressed by the pressure of the compressed air and is sequentially inserted upward inside the lateral pipe 12 while being everted, as shown in FIG. 7.

When the lateral-pipe lining material 2 has been inserted by eversion into the lateral pipe 12, hot water is fed from the distal end of the hot-water hose 41 to fill the airtight space with hot water in a state in which the lateral-pipe lining material 2 is pressed against the internal peripheral surface of the lateral pipe 12. The compressed air inside the airtight space is discharged to the atmosphere through the drainage hose 62, and the thermosetting resin impregnated in the pipe-shaped resin absorbent material 201 of the lateral-pipe lining material 2 is heated and cured by the hot water.

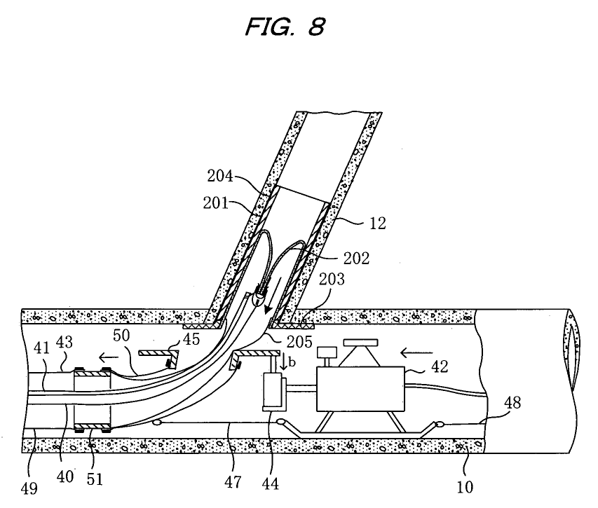

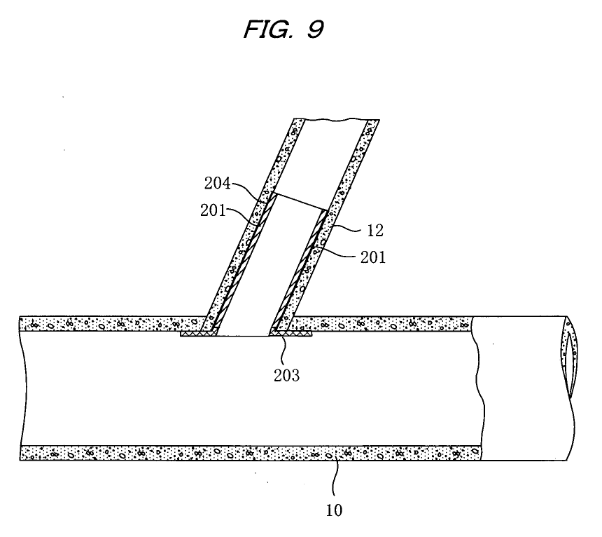

When the resin impregnated in the pipe-shaped resin absorbent material 201 has cured, the hot water is let out from the airtight space through the drainage hose 56 and returned to the hot-water tank 55. The head 44 of the work robot 42 is moved downward in the direction of arrow b in the drawing, and the positioning nozzle 45 is removed from the flange 203 of the lateral-pipe lining material 2, as shown in FIG. 8, after which the drawing rope 40 is pulled in the direction of the arrow (leftward in FIG. 8). At this time, the peel-away tube 205 and the tube 202 covering the pipe-shaped resin absorbent material 201 from the interior are pulled in the same direction, and the tube 202 is removed from the pipe-shaped resin absorbent material 201. The work robot 42, the pressure bag 43, and the like are removed from the inside of the main pipe 10, whereby the internal peripheral surface of the lateral pipe 12 is lined by the pipe-shaped resin absorbent material 201, as shown in FIG. 9.

The internal peripheral surface of the lateral pipe 12 thus lined is a firm resin surface composed of the pipe-shaped resin absorbent material 201 of the lateral-pipe lining material 2 and having no coating layer. The coefficient of roughness of the internal peripheral surface of the rehabilitated lateral pipe is reduced and quantity of the flow of sewage inside the lateral pipe can be increased in the same manner as the internal peripheral surface of the main pipe of the embodiment 1 described above.

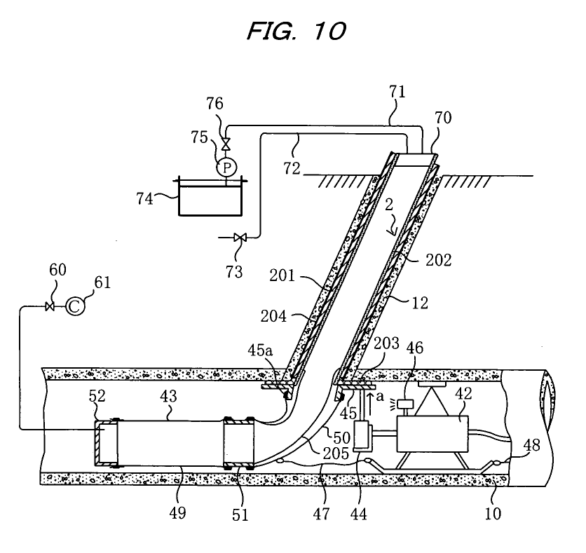

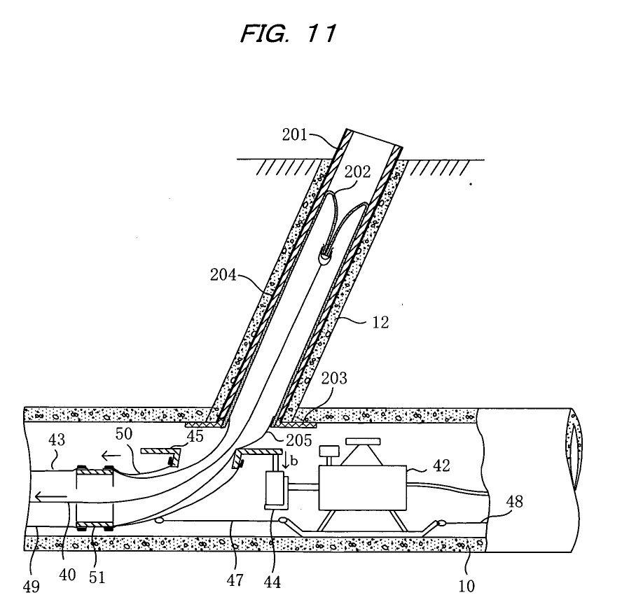

The lining of the lateral pipe shown in FIGS. 6 to 9 is a lining that reaches midway into the lateral pipe, but FIGS. 10 and 11 show examples of lining that extends the lateral-pipe lining material to aboveground through the entire lateral pipe. The same reference numerals are used for the same parts as FIGS. 6 to 9, and a detailed description of these parts is omitted.

In this example, a drawing rope and a hot water hose are not connected to the distal end of the tube 202 of the lateral-pipe lining material 2, and a closed airtight state is formed. The lateral-pipe lining material 2 is inserted by eversion into the lateral pipe 12 and protrudes aboveground when compressed air is fed from the compressor 61 into the pressure bag 43, as shown in FIG. 10. In this case, an attachment 70 is connected in an airtight manner to the lateral-pipe lining material, which has protruded aboveground.

The valve 60 is closed, the valves 73, 76 are opened, and a steam pump 75 is driven so as to feed steam from a steam tank 74 into the airtight space through the steam hose 71, whereby air is discharged to the atmosphere through an air discharge hose 72. On the other hand, the lateral-pipe lining material 2 is heated while pressed against the internal peripheral wall of the lateral pipe 12, and the thermosetting resin impregnated in the pipe-shaped resin absorbent material 201 is cured.

After the thermosetting resin has been cured, the attachment 70 is removed, and the drawing rope 40 is tied to the tube 202 of the lateral-pipe lining material 2, as shown in FIG. 11. Since the tube 202 is not secured to the pipe-shaped resin absorbent material 201, the tube 202 can be readily separated and removed from the pipe-shaped resin absorbent material 201 when the drawing rope 40 is pulled, and the internal peripheral surface of the rehabilitated lateral pipe 12 can be made into a cured resin surface.

The curing of the lateral-pipe lining material 2 can also be achieved by hot water or hot water showering other than steam.

In the case that the tube 202 of the lateral-pipe lining material 2 is not secured in any way to the pipe-shaped resin absorbent material 201, the tube 202 is liable to become positionally displaced with respect to the pipe-shaped resin absorbent material 201. Therefore, the tube 202 and the pipe-shaped resin absorbent material 201 may be partially and temporarily secured by heat fusion or bonding. In this case as well, the range of heat fusion and the number of locations for heat fusion is established in the same fashion as that described for the main-pipe lining material 1 so that the tube 202 can be readily peeled away from the cured pipe-shaped resin absorbent material 201.

The liquid curable resin impregnated in the pipe-shaped resin absorbent material as shown in FIG. 1, FIGS. 6 to 9, or FIGS. 10, 11 is not limited to a resin cured by heating with a heat medium, such as steam, hot water, or the like. It is also possible to use a resin cured by radiating UV rays or other light, or a resin that cures at a normal temperature.

What is claimed is:

1. A pipe-lining material for insertion into an existing pipe and rehabilitation of the internal peripheral surface of the existing pipe, comprising;
a pipe-shaped resin absorbent material impregnated with a liquid curable resin; and
a tube covering the external peripheral surface or the internal peripheral surface of the pipe-shaped resin absorbent material, the tube being removably attached to the pipe-shaped resin absorbent material.

2. The pipe-lining material according to claim 1, wherein the tube of the pipe-lining material covers the pipe-shaped resin absorbent material without being secured thereto.

3. The pipe-lining material according to claim 1, wherein the tube of the pipe-lining material is partially fused or bonded to the pipe-shaped resin absorbent material in a peelable fashion and covers the pipe-shaped resin absorbent material.

4. The pipe-lining material according to claim 1, wherein the pipe-lining material is inserted into the existing pipe by eversion or drawing.

5. The pipe-lining material according to claim 1, wherein the pipe-lining material is a pipe-lining material for rehabilitating a main pipe or a lateral pipe that branches from the main pipe.

6. The pipe-lining material according to claim 1, wherein the liquid curable resin is a resin that cures by heat or light irradiation, or a resin that cures at normal temperature.

7. A pipe-lining method for rehabilitating the internal peripheral surface of an existing pipe using a pipe-lining material, said method comprising:
inserting a pipe-lining material having a pipe-shaped resin absorbent material and a tube into an existing pipe so that the pipe-shaped resin absorbent material faces outward and the tube faces inward, the pipe-lining material having a pipe-shaped resin absorbent material impregnated with a liquid curable resin, and the tube covering the external peripheral surface or the internal peripheral surface of the pipe-shaped resin absorbent material and being removable from the pipe-shaped resin absorbent material;
curing the curable resin impregnated in the pipe-shaped resin absorbent material in a state in which the pipe-lining material is pressed against the internal peripheral surface of the existing pipe;
curing the curable resin impregnated in the pipe-shaped resin absorbent material; and
subsequently removing the tube covering the pipe-shaped resin absorbent material from the pipe-shaped resin absorbent material so that the surface of the pipe-shaped resin absorbent material having the cured resin will be the internal peripheral surface of the rehabilitated existing pipe.

8. The pipe-lining method according to claim 7, wherein the tube of the pipe-lining material covers the pipe-shaped resin absorbent material without being secured thereto.

9. The pipe-lining method according to claim 7, wherein the tube of the pipe-lining material is partially fused or bonded to the pipe-shaped resin absorbent material in a peelable fashion and covers the pipe-shaped resin absorbent material.

10. The pipe-lining method according to claim 7, wherein the pipe-lining material is inserted into the existing pipe by eversion or drawing.

11. The pipe-lining method according to claim 7, wherein the pipe-lining material is a pipe-lining material for rehabilitating a main pipe or a lateral pipe that branches from the main pipe.

12. The pipe-lining method according to claim 7, wherein the liquid curable resin is a resin that cures by heat or light irradiation, or a resin that cures at normal temperature.
